(19) United States
(12) Patent Application Publication
(10) Pub. No.: US 2023/0051868 A1
(43) Pub. Date: Feb. 16, 2023

(54) Livestreaming Interaction Method And Apparatus, Electronic Device, And Computer Readable Storage Medium

(71) Applicant: Xiamen Yaji Software Co., Ltd, Xiamen, Fuijan (CN)

(72) Inventors: Jing Du, Xiamen, Fujian (CN); Shun Lin, Xiamen, Fujian (CN)

(73) Assignee: Xiamen Yaji Software Co., Ltd, Xiamen, Fuijan (CN)

(21) Appl. No.: 17/786,750

(22) PCT Filed: Sep. 18, 2020
(86) PCT No.: PCT/CN2020/116216

§ 371 Date: Jun. 17, 2022

(30) Foreign Application Priority Data
Dec. 25, 2019 (CN) 201911360832.3

(51) Int. Cl. A63F 13/86; H04N 21/2187; H04N 21/478; H04N 21/4788; A63F 13/48; A63F 13/55; A63F 13/71

(52) U.S. Cl. CPC A63F 13/86; H04N 21/2187; H04N 21/4781; H04N 21/4788; A63F 13/48; A63F 13/55; A63F 13/71; A63F 13/87

(57) ABSTRACT

The disclosure provides a live streaming interaction method and apparatus, an electronic device, and a computer-readable storage medium. The method comprises: receiving an invitation request from a first terminal; transmitting the invitation request to a second terminal, and receiving an acceptance information for the invitation request that is returned by the second terminal; and on the basis of the acceptance information, transmitting to a viewer terminal a connection instruction used for connecting with a second GS so that the viewer terminal stops the connection with a live streaming server and connects to the second GS so as to control a character of the same game as an anchor terminal. In the live streaming interaction method disclosed in the disclosure, a game can be combined with live streaming.

### CROSS-REFERENCES TO RELATED APPLICATIONS

The present application is a U.S. national entry, filed under 35 U.S.C. § 371 of International Patent Application No. PCT/CN2020/116216, filed Sep. 18, 2020, which claims the priority of China Patent Application 201911360832.3, filed on Dec. 25, 2019, the disclosure of which is hereby incorporated by reference herein in its entirety.

### TECHNICAL FIELD

The disclosure relates to the field of Internet technologies. Specifically, the disclosure relates to a live streaming interaction method, apparatus, electronic device, and computer-readable storage medium.

### BACKGROUND

With the development of information technology and the rapid development of Internet technology, the live streaming industry came into being. Diversified live streaming content is being pursued by major live streaming platforms. More and more users conduct online entertainment, marketing meetings, and even game live streaming through various live streaming platforms. In particular, the game live streaming can enhance the interaction between the anchor and the viewer, which has a greater appeal.

In recent years, with the emergence of cloud gaming, due to the advantages of cloud gaming, for example, all games in cloud gaming run on the cloud gaming server, with lower hardware requirements for terminal device, which has become increasingly popular with major live streaming platforms as well as major anchors. How to take the advantages of cloud gaming to combine game and live streaming is a key issue.

### SUMMARY

In a first aspect, a live streaming interaction method is provided, comprising:

receiving an invitation request from a first terminal;

transmitting the invitation request to a second terminal, and receiving acceptance information for the invitation request returned by the second terminal;

transmitting a connection instruction for connecting with a second GS to a viewer terminal based on the acceptance information, so that the viewer terminal disconnects with a live streaming server and connects with the second GS to control a character of a same game as an anchor terminal;

wherein, the anchor terminal is connected to a first GS; the first GS and the second GS are used to control game instance(s) of the same game; the viewer terminal is one of a first and second terminal; and the anchor terminal is the other one of the first terminal and the second terminal except the viewer terminal.

Optionally, the anchor terminal is the first terminal; the viewer terminal is the second terminal; the invitation request carries interaction information; the interaction information includes an interactive game and the number of interactive people designated by the anchor terminal.

Optionally, the interaction information further includes interaction rules; transmitting the invitation request to a second terminal includes:

broadcasting the interaction information to multiple user terminals in a live streaming room respectively; and

searching for a user terminal that meets the interaction rules, taking the found user terminal as a viewer terminal, and transmitting the invitation request to the viewer terminal.

Optionally, the interaction information further includes information from a viewer terminal designated by the anchor terminal; transmitting the invitation request to a second terminal comprises:

transmitting the invitation request to the viewer terminal designated by the anchor terminal.

Optionally, both the first GS and the second GS are integrated in a same game;

or, both the first GS and the second GS are independent of a same game, and both the first GS and the second GS are used to control a same game instance of the same game;

or, the first GS and the second GS are both independent of a same game, the first GS is used to control one game instance of the same game, and the second GS is used to control another game instance of the same game.

Optionally, the method further includes: before transmitting a connection instruction for connecting with a second GS to a viewer terminal based on the acceptance information,

transmitting an authorization request to the anchor terminal, the authorization request being used to request to transmit a connection instruction to the viewer terminal; and

receiving authorization confirmation information from the anchor terminal.

In a second aspect, a live streaming interaction method is provided, comprising:

establishing a connection with a first GS;

transmitting an invitation request to a signaling server, transmitting the invitation request to a viewer terminal through the signaling server, and receiving acceptance information from the viewer terminal; or, receiving an invitation request from a viewer terminal sent by a signaling server, and transmitting the acceptance information to the signaling server; and

transmitting a connection instruction for connecting with a second GS to the viewer terminal through the signaling server, so that the viewer terminal disconnects with a live streaming server and connects with the second GS, so that the viewer terminal can control a character of a same game as an anchor terminal, the first GS and the second GS being used to control game instance (s) of a same game.

Optionally, the method further comprises:

receiving an authorization request from the signaling server; and

transmitting authorization confirmation information to the signaling server, the authorization confirmation information being used to instruct the signaling server to transmit a connection instruction to the viewer terminal.

In a third aspect, a live streaming interaction method is provided, which includes:

transmitting an invitation request to a signaling server, transmitting the invitation request to an anchor terminal through the signaling server, and receiving acceptance information from the anchor terminal; or receiving an invitation request from the anchor terminal sent by a signaling server, and transmitting the acceptance information to the signaling server, the anchor terminal being connected to a first GS;

receiving a connection instruction for connecting with a second GS sent by the signaling server; the first GS and the second GS are used to control game instance(s) of a same game; and

disconnecting with a live streaming server, and connecting with the second GS based on the connection instruction to control a character of the same game as the anchor terminal.

In a fourth aspect, a live streaming interaction method is provided, and the method comprises:

transmitting an invitation request to a signaling server by an anchor terminal, and transmitting the invitation request to a viewer terminal and receiving acceptance information from the viewer terminal the signaling server; or transmitting an invitation request to a signaling server by the viewer terminal, and transmitting the invitation request to the anchor terminal, and receiving the acceptance information from the anchor terminal by the signaling server, the anchor terminal being connected to a first GS;

transmitting a connection instruction for connecting with a second GS to the viewer terminal by the signaling server, the first GS and the second GS being used to control game instance(s) of a same game; and

based on the connection instruction, the viewer terminal disconnects with a live streaming server and connects with the second GS to control a character of a same game as the anchor terminal.

In a fifth aspect, a live streaming interaction apparatus is provided, comprising:

a first receiving module configured to receive an invitation request of a first terminal;

a second receiving module configured to transmit the invitation request to a second terminal, and receive acceptance information for the invitation request returned by the second terminal; and

a first operation module configured to transmit a connection instruction for connecting with a second GS to a viewer terminal based on the acceptance information, so that the viewer terminal disconnects with a live streaming server and connects with the second GS to control a character of a same game as an anchor terminal.

Here, the anchor terminal is connected to a first GS; the first GS and the second GS are used to control game instance of the same game; the viewer terminal is one of a first and second terminal; and the anchor terminal is the other one of the first terminal and the second terminal except the viewer terminal.

Optionally, the anchor terminal is the first terminal; the viewer terminal is the second terminal; the invitation request carries interaction information; the interaction information includes an interactive game and the number of interactive people designated by the anchor terminal.

Optionally, the interaction information further includes interaction rules; and when the second receiving module transmits the invitation request to the second terminal, the second receiving module is specifically configured for:

broadcasting the interaction information to multiple user terminals in a live streaming room respectively; and

searching for a user terminal that meets the interaction rules, taking the found user terminal as a viewer terminal, and transmitting the invitation request to the viewer terminal.

Optionally, the interaction information further includes a viewer terminal designated by the anchor terminal; and when the second receiving module transmits the invitation request to the second terminal, the second receiving module is specifically configured for:

transmitting the invitation request to the viewer terminal designated by the anchor terminal.

Optionally, both the first GS and the second GS are integrated in a same game;

or, both the first GS and the second GS are independent of a same game, and both the first GS and the second GS are used to control a same game instance of the same game;

or, the first GS and the second GS are both independent of a same game, the first GS is used to control one game instance of the same game, and the second GS is used to control another game instance of the same game.

Optionally, the live streaming interaction apparatus further includes a first authorization module, and the first authorization module is configured for:

transmitting an authorization request to the anchor terminal, the authorization request being used to request to transmit a connection instruction to the viewer terminal; and

receiving authorization confirmation information from the anchor terminal.

In a sixth aspect, a live streaming interaction apparatus is provided, comprising:

a connecting module configured to establish a connection with a first GS;

a first transmitting module configured to transmit an invitation request to a signaling server, transmit the invitation request to a viewer terminal through the signaling server, and receive acceptance information from the viewer terminal; or, receive an invitation request from a viewer terminal sent by a signaling server, and transmit the acceptance information to the signaling server; and

a second operation module configured to transmit a connection instruction for connecting with a second GS to the viewer terminal through the signaling server, so that the viewer terminal disconnects with a live streaming server and connects with the second GS, so that the viewer terminal can control a character of a same game as an anchor terminal, the first GS and the second GS being used to control game instance of a same game.

Optionally, the live streaming interaction apparatus further includes a second authorization module, and the second authorization module is configured to:

receive an authorization request from the signaling server; and

transmitting authorization confirmation information to the signaling server, the authorization confirmation information being used to instruct the signaling server to transmit a connection instruction to the viewer terminal.

In a seventh aspect, a live streaming interaction apparatus is provided, comprising:

a second transmitting module configured to transmit an invitation request to a signaling server, transmit the invitation request to an anchor terminal through the signaling server, and receive acceptance information from the anchor terminal; or receive an invitation request from the anchor terminal sent by a signaling server, and transmit the acceptance information to the signaling server, the anchor terminal being connected to a first GS;

a third receiving module configured to receive a connection instruction for connecting with a second GS sent by the signaling server, the first GS and the second GS being used to control game instance (s) of a same game; and

a third operation module configured to disconnect with a live streaming server, and connect with the second GS based on the connection instruction to control a character of the same game as the anchor terminal.

In an eighth aspect, an electronic device is provided, comprising:

one or more processors;

a memory; and

one or more application programs, the one or more application programs being stored in the memory and configured to be executed by the one or more processors, the one or more programs being configured to perform the live streaming interaction method shown in the first aspect of the disclosure.

In a ninth aspect, a computer-readable storage medium is provided, a computer program is stored on the computer-readable storage medium, and, when the computer program is executed by a processor, the live streaming interaction method according to any one of the first aspect to the fourth aspect is realized.

The good technical effects brought about by the technical solutions provided by the disclosure are:

The anchor terminal transmits an invitation request to the signaling server, and the signaling server transmits the invitation request to the viewer terminal and receives the acceptance information from the viewer terminal. Or, the viewer terminal transmits an invitation request to the signaling server, and the signaling server transmits the invitation request to the anchor terminal and receives acceptance information from the anchor terminal. The anchor terminal is connected to the first GS; and the signaling server transmits a connection instruction for connecting with the second GS to the viewer terminal. The viewer terminal disconnects with the live streaming server and connects with the second GS based on the connection instruction. The first GS and the second GS control game instance of the same game, so the game and live streaming are combined. During the live streaming, the anchor terminal and the viewer terminal can control the same or different characters of the same game, so that in the live streaming system, the anchor and the viewer can directly establish and complete the interaction in the game.

The additional aspects and advantages of the disclosure will be partly given in the following description, which will become obvious from the following description, or be understood through the practice of the disclosure.

### BRIEF DESCRIPTION OF THE DRAWINGS

In order to illustrate the technical solutions more clearly in the embodiments of the disclosure, the following briefly introduces the drawings required for describing the embodiments of the disclosure.

FIG. 1 is a schematic diagram of an application background of a method of live streaming interaction according to an embodiment of the disclosure.

FIG. 2 is a schematic diagram of an application environment of a method of live streaming interaction according to an embodiment of the disclosure.

FIG. 3 is a schematic flowchart of a method of live streaming interaction according to an embodiment of the disclosure.

FIG. 4 is a schematic diagram of a relationship among a first GS, a second GS and a game instance according to an embodiment of the disclosure.

FIG. 5 is a schematic diagram of a relationship among a first GS and a second GS and a game instance according to an embodiment of the disclosure.

FIG. 6 is a schematic diagram of a relationship among a first GS, a second GS and a game instance according to an embodiment of the disclosure.

FIG. 7 is a schematic diagram of a relationship among a first GS, a second GS and a game instance according to an embodiment of the disclosure.

FIG. 8 is a schematic flowchart of a method of live streaming interaction according to an embodiment of the disclosure.

FIG. 9 is a schematic flowchart of a method of live streaming interaction according to an embodiment of the disclosure.

FIG. 10 is a schematic flowchart of a method of live streaming interaction according to an embodiment of the disclosure.

FIG. 11 is a timing diagram of a method of live streaming interaction according to an example of the disclosure.

FIG. 12 is a timing diagram of a method of live streaming interaction according to an example of the disclosure.

FIG. 13 is a schematic structural diagram of an apparatus for live streaming interaction according to an embodiment of the disclosure.

FIG. 14 is a schematic structural diagram of an apparatus for live streaming interaction according to an embodiment of the disclosure.

FIG. 15 is a schematic structural diagram of an apparatus for live streaming interaction according to an embodiment of the disclosure.

FIG. 16 is a schematic structural diagram of an electronic device for live streaming interaction according to an embodiment of the disclosure.

### DETAILED DESCRIPTION

The embodiments of the disclosure are described in detail below. Examples of the embodiments are shown in the accompanying drawings, in which the same or similar reference numerals indicate the same or similar elements or elements with the same or similar functions. The embodiments described below with reference to the drawings are exemplary, and are only used to explain the disclosure, and cannot be construed as limiting the disclosure.

Those skilled in the art can understand that, unless specifically stated otherwise, the singular forms “a”, “an”, “said” and “the” used herein may also include plural forms. It should be further understood that the term “comprising” used in the specification of the present disclosure refers to the presence of the described features, integers, steps, operations, elements and/or components, but does not exclude the presence or addition of one or more other features, integers, steps, operations, elements, components, and/or combinations thereof. It should be understood that when we refer to an element as being “connected” or “coupled” to another element, the element may be directly connected or coupled to the other element, or intervening elements may be present. In addition, “connected” or “coupled” used herein may include wireless connection or wireless coupling. The term “and/or” used herein includes all or any unit and all combinations of one or more associated listed items.

In order to make the objects, technical solutions, and advantages of the present disclosure clearer, the implementations of the present disclosure will be further described in detail below in conjunction with the accompanying drawings.

The game live streaming adopts the same platform as other scenes, such as talent live streaming. The live streaming system distributes the content of an anchor to multiple viewers in a live streaming room, and the video should be sliced and cached. Pushing-streaming of anchor generally uses Real Time Messaging Protocol (RTMP) as the application layer protocol, that is, the anchor terminal pushes the RTMP stream to the live streaming server; and pulling-streaming generally uses RTMP, HTTP-based streaming media network transmission protocol (HTTP Live Streaming, HLS) or HDL (Full name: HTTP Deliver Living) (or HLV (full name: HTTP Live Video)) as the application layer protocol. Here, the transport layer protocols corresponding to the pushing-streaming and the pulling-streaming are both Transmission Control Protocol (TCP) protocols, as shown in FIG. 1.

Specifically, the process of the game live streaming may include: a process of live streaming of pushing-streaming content at the anchor terminal and a process of a down-streaming at the viewer terminal to watch the live streaming.

Here, the process of live streaming of pushing-streaming content at the anchor terminal may include: obtaining an address, port and authorization key of an pushing-streaming server address, when the anchor logs in to a live streaming account, enters a management page and creates a live streaming room at the anchor terminal; then, the anchor, when starting the Instant Messaging (IM) tool and logging in to the live streaming account at the anchor terminal, entering the live streaming room to chat with the viewers in the live streaming room in video and graphic text; and then, running a native game on a local terminal, starting OBS (Open Broadcaster Software) or similar screen recording software to complete the necessary settings for screen recording and streaming, beginning to pushing-streaming to a corresponding pushing-streaming server in the live streaming room, so that a viewer terminal can get the game screen and game sound from the anchor terminal.

Here, the process of a viewer pulling-streaming to watch the live streaming may include:

when a viewer at the viewer terminal enters the live streaming room by logging in to a live streaming account (or as a visitor), the viewer can chat with the anchor and other viewers in the live streaming room, and can also watch the game that the anchor may be playing in case of up-streaming by the anchor terminal.

Further, in addition to the traditional processes of live streaming of pushing-streaming content at the anchor terminal and of live streaming of pulling-streaming content at the viewer terminal, the anchor terminal can also interact with certain viewer terminals in the live streaming room to increase the interest of the game live streaming.

Based on the above solutions, the following technical problems may exist. 1. The traditional game interaction is based on online games. In-game interaction is realized on the game platform, and it is impossible to directly establish in-game interaction with the anchor on the live streaming platform; accordingly, in the traditional, in order to achieve game interaction, the viewer and anchor need to exit from the live streaming platform (or other similar methods) to switch to the game in order to interact with the anchor in the game, or, the viewer needs to operate two devices, one is used to interact with the anchor's game, and the other is used to watch the anchor's live streaming. 2. The anchor has multiple game accounts, when the characters of multiple game accounts want to interact with each other, the anchor needs to share the game account passwords first, and then realize the game interaction (the anchor may not wish to share the game account password directly), or, if the viewer does not have a game account or is unfamiliar with the game, the viewer needs to apply for practicing the game (or the account reaches a certain level) first, and then interacts with the anchor; or if the viewer does not have the game installed, the viewer needs to install the game first, and then interacts with the anchor; this can easily lead to the number loss of game users and the leakage of the anchor's game account and key. 3. During the traditional live streaming of the game, two or more people cheating in game may occur according to the game interaction solutions, which reduces the significance of game interaction with the viewer terminal in the live streaming room during the game live streaming. 4. For console games and weakly networked games, the viewer cannot interact with the anchor in the game through the live streaming platform.

The live streaming interaction method, apparatus, electronic device, and computer-readable storage medium provided in the disclosure are intended to solve the above technical problems in the prior art.

The live streaming interaction method according to the embodiments of the disclosure may be applicable to a live streaming system, and the system may include: an anchor terminal, a cloud, and viewer terminals (first viewer terminal and other viewer terminals) in the live streaming room. The cloud includes: a signaling server, a live streaming server, and a cloud gaming server. The cloud gaming server includes: a certain game instance and game service (Game Service, GS) running therein. Each live streaming room generally has a GS (referred to as the master GS) that controls the main character in the game; further, the anchor terminal can exchange information with each viewer terminal in the live streaming room through the signaling server; the anchor terminal can directly exchange information with each viewer terminal in the live streaming room through the live streaming server; and the anchor terminal can exchange information with the viewer terminals through the cloud gaming server and the live streaming server. Of course, in the embodiments of the disclosure, both the viewer terminal and the anchor terminal can exchange information with the cloud gaming server through P2P connection.

In order to better illustrate the solutions of the embodiments of the present disclosure, related technical terms involved in the embodiments of the present disclosure are first introduced and explained below.

Cloud gaming is based on cloud computing. In the running mode of cloud gaming, all games are running on the server terminal, and the rendered game screen is compressed and transmitted to the user through the network. At the user terminal (anchor terminal or viewer terminal), the user's game device does not require any high-end processor and graphics card, and only require basic video decompression capabilities. Cloud computing is a computing method based on the Internet. In this way, shared software and hardware resources and information can be provided to computers and other devices on demand.

In the current cloud gaming solutions, since the game instance runs on the server terminal, a component is required. This component corresponds to the game instance and runs on the same server, and the component can provide cloud gaming services externally. This component is a game service. The function of the game service includes: controlling the game process (for example, starting, exiting the game instance, changing the settings, etc.), receiving the control instructions sent by the corresponding client and simulating the control of the game instance, capturing, encoding, and transmitting the game screen and the game sound in real time to the corresponding client. During the game live streaming process, the corresponding client can be any anchor terminal or viewer terminal that establishes a P2P connection with GS.

P2P is an abbreviation for Peer-to-peer networking. Peer-to-peer network, that is, peer-to-peer computer network, is a distributed application architecture that distributes tasks and workloads among peers, and is a networking or network form formed by a peer-to-peer computing model at the application layer. In the P2P network environment, the multiple terminals connected to each other are in a peer-to-peer position, and each terminal has no master and slave. Each terminal can not only act as a requester of network services, but also respond to requests from other computers to provide resources, services, and content.

In the process of game live streaming, if the anchor terminal and viewer terminal intend to directly realize the in-game interaction in the live streaming system, they need to establish a data channel that transmits interaction information between them. The signaling server is the component that provides the data channel service. Long connections can be established among the signaling server, the anchor terminal, viewer terminal and game service terminal to facilitate broadcast or directed forwarding of data messages. Here, a long connection refers to that multiple data packets can be sent continuously on a connection. During the connection period, if no data packet is sent, both parties need to transmit a link detection packet.

The technical solutions of the disclosure and how the technical solutions of the disclosure solve the above technical problems are described in detail below with specific embodiments. The following specific embodiments can be combined with each other, and the same or similar concepts or processes may not be repeated in some embodiments. The embodiments of the disclosure will be described below in conjunction with the accompanying drawings.

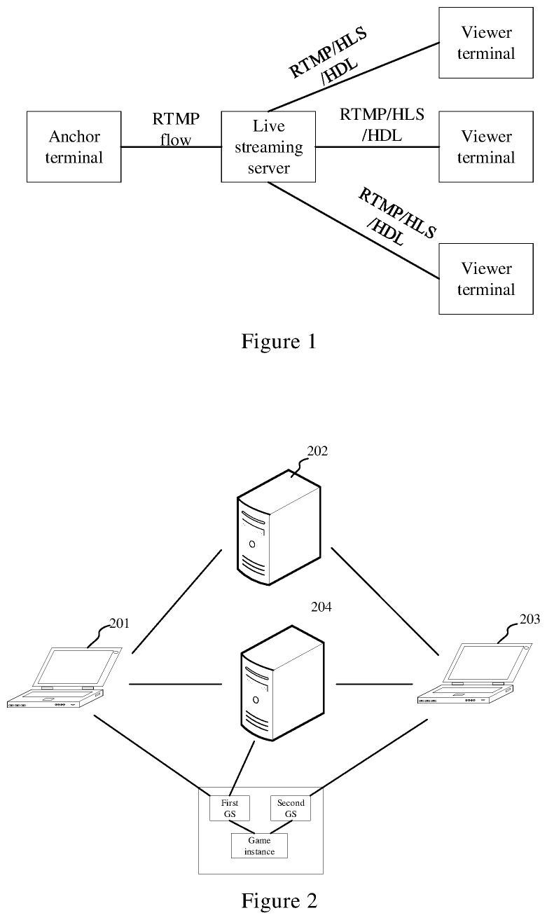

The live streaming interaction method provided in the disclosure may be applicable to the application environment shown in FIG. 2. Specifically, in FIG. 2, an anchor terminal 201 is connected to a first GS, the anchor terminal 201 can transmit an invitation request to a signaling server 202, and the signaling server 202 can transmit the invitation request to a viewer terminal 203 and receive acceptance information from the viewer terminal 203. The signaling server 202 can transmit a connection instruction for connecting with a second GS to the viewer terminal 203, and the viewer terminal 203 can disconnect with a live streaming server 204 and connect with the second GS based on the connection instruction. The first GS and the second GS can be used to control a game instance of the same game, so that the viewer terminal 203 can control the characters of the same game as the anchor terminal 201.

According to a possible implementation of the embodiments of the disclosure, as shown in FIG. 3, a live streaming interaction method is provided, which is applicable to a signaling server and may include the following steps.

Step S301, an invitation request is received from a first terminal.

Here, the first terminal may be an anchor terminal in a live streaming, or a viewer terminal in a live streaming.

Step S302, the invitation request is transmitted to a second terminal, and acceptance information for the invitation request returned is received from the second terminal.

Specifically, the second terminal can be an anchor terminal or a viewer terminal in a live streaming. When the signaling server receives the invitation request from the anchor terminal, the signaling server transmits the invitation request to the viewer terminal; and when the signaling server receives the invitation request from the viewer terminal, the signaling server transmits the invitation request to the anchor terminal.

It should be noted that the invitation request from the anchor terminal and the invitation request from the viewer terminal may carry different information, which will be described in detail below.

Step S303, a connection instruction for connecting with a second GS is transmitted to a viewer terminal based on the acceptance information, so that the viewer terminal disconnects with a live streaming server and connects with the second GS to control a character of a same game as an anchor terminal.

Here, the same game as the anchor terminal means that the game where the character controlled by the viewer terminal is located and the game where the character controlled by the anchor terminal is located are the same game.

Here, the anchor terminal is connected with the first GS. The first GS and the second GS are used to control game instance(s) of the same game. For example, the first GS and the second GS can control the identical game instance of the same game. For another example, the first GS controls one game instance of the same game, and the second GS controls another game instance of the same game. When the viewer terminal is connected with the second GS, the viewer terminal can control the character of the same game as the anchor terminal. The specific relationship between the first GS and the second GS will be further explained below.

In the implementation process, the viewer terminal can control a character of a same game as the anchor terminal, or control different characters of a same game as the anchor terminal. Whether the specific controlled characters are the same is not limited here.

Specifically, the viewer terminal is one of the first terminal and the second terminal; and the anchor terminal is the other one of the first terminal and the second terminal except the viewer terminal.

In the above embodiments, the anchor terminal transmits an invitation request to the signaling server, and the signaling server transmits the invitation request to the viewer terminal and receives the acceptance information from the viewer terminal. Or, the viewer terminal transmits an invitation request to the signaling server, and the signaling server transmits the invitation request to the anchor terminal and receives acceptance information from the anchor terminal. The anchor terminal is connected with the first GS; and the signaling server transmits a connection instruction for connecting with the second GS to the viewer. The viewer terminal disconnects with the live streaming server and connects with the second GS based on the connection instruction. The first GS and the second GS control game instance(s) of the same game, thereby combining the game with live streaming is achieved. Therefore, the anchor terminal and the viewer terminal can control the same or different characters of the same game during the live streaming.

According to a possible implementation of the embodiments of the disclosure, the anchor terminal is the first terminal, the viewer terminal is the second terminal, the invitation request carries interaction information, and the interaction information includes the name or the identification of an interactive game and the number of interactive people designated by the anchor terminal.

In other words, the anchor terminal transmits the invitation request to the signaling server, and the signaling server transmits the invitation request to the viewer terminal and receives the acceptance information from the viewer terminal. Here, the invitation request sent by the anchor terminal can carry interaction information, that is, the anchor terminal can specify the interactive game and the number of interactive people.

According to a possible implementation of the embodiments of the disclosure, where the interaction information further includes interaction rules; and the invitation request is transmitted to a second terminal in Step S302 includes the several steps.

(1) The interaction information is broadcast to multiple user terminals in a live streaming room respectively.

Here, the user terminal may include an anchor terminal in a live streaming room and all viewer terminals.

(2) A user terminal that meets the interaction rules is searching for, the searched user terminal is taken as a viewer terminal, and the invitation request is transmitted to the viewer terminal.

Specifically, when the anchor terminal transmits the invitation request to the viewer terminal, the anchor terminal can specify the interactive game and the number of interactive people, as well as the interaction rules. The interaction rules may include the operation rules of the viewer terminal, for example, gifts are sent within a designated time, or the gifts sent reaches the designated quantity, or interaction with the anchor.

The anchor terminal can transmit the invitation request to the signaling server, and the signaling server broadcasts the interaction information in the invitation request to all user terminals in the live streaming room, i.e., broadcasts to the anchor terminal and all viewer terminals in the live streaming room. For example, the anchor terminal invites 4 people to play a football/basketball game. The 4 viewer terminals that reply “1” fastest among all the viewer terminals in the live streaming room can play the game with the anchor terminal. The signaling server monitors the reply information from all viewer terminals, determines the 4 viewer terminals that reply “1” the fastest, and transmits the invitation request to these 4 viewer terminals. After the signaling server receives the acceptance information of the four viewer terminals, it transmits connection notification to the four viewer terminals respectively, so that the four viewer terminals and the anchor terminal simultaneously control different characters in the football/basketball game.

In other implementation processes, when the anchor terminal transmits an invitation request to the viewer terminals, the anchor terminal can specify the interactive game and the number of interactive people, and the signaling server can also obtain the preset default rules, and select the viewer terminals according to the default rules.

The anchor terminal can transmit an invitation request to the signaling server, and the signaling server broadcasts the interaction information in the invitation request to all user terminals in the live streaming room, i.e., broadcasts to the anchor terminal and all viewer terminals in the live streaming room. However, the interactive rules are set to be the default rules. Assuming that the anchor terminal invites 4 people to play a football/basketball game, the default rules in the signaling server are that the viewer terminals at which viewers respond to the message fastest in the live streaming room can play the game with the anchor terminal. The signaling server monitors the reply information of all viewer terminals, determines the 4 viewer terminals that reply the fastest, and transmits the invitation request to these 4 viewer terminals. After the signaling server receives the acceptance information of the 4 viewer terminals, the signaling server transmits connection notification to the 4 viewer terminals respectively, so that the 4 viewer terminals and the anchor terminal simultaneously control different characters of the football/basketball game.

According to a possible implementation of the embodiments of the disclosure, the interaction information further includes a viewer terminal designated by the anchor terminal; step S302 of the invitation request being transmitted to a second terminal may include the following step.

The invitation request is transmitted to the viewer terminal designated by the anchor terminal.

Specifically, the anchor terminal can specify not only interactive games and the number of interactive people, but also viewer terminals.

The anchor terminal can transmit an invitation request to the signaling server, and the signaling server broadcasts the interaction information in the invitation request to all user terminals in the live streaming room, i.e., broadcasts to the anchor terminal and all viewer terminals in the live streaming room. For instance, the anchor terminal invites four viewer terminals A, B, C and D to play a football/basketball game with the anchor terminal. When any one of the viewer terminals A, B, C and D transmits an acceptance information, the signaling server can also broadcast the acceptance information to all user terminals in the live streaming room. For example, viewer terminal A accepts the invitation request from the anchor terminal and is ready to enter the game with the anchor terminal, etc. When the signaling server receives the acceptance information of the 4 viewer terminals, the signaling server transmits connection notification to the 4 viewer terminals respectively, so that the 4 viewer terminals and the anchor terminal simultaneously control different characters of the football/basketball game.

Of course, if the signaling server does not receive acceptance information of the viewer terminal designated by the anchor terminal within a preset time, the signaling server can return a notification of the invitation failure to the anchor terminal. The signaling server can also re-receive the information for designating the viewer terminal from the anchor terminal, or the signaling server can automatically select other viewer terminals and transmit the invitation request. The signaling server may transmit the invitation request of the viewer terminal in multiple ways, which is not limited here.

The relationship among the first GS, the second GS and the game instance(s) of the same game will be further explained below in conjunction with the drawings and embodiments.

Both the first GS and the second GS can be used to control the game process, such as setting the game, and can also be used to receive control instructions from remote users to complete simulation control. That is, the first GS and the second GS simulate the control of the game by the anchor terminal and the viewer terminal, and synchronously captures the screen and sound of the game, and encodes them into an audio and video stream, and transmits them to the anchor terminal or the viewer terminal in real time. The master control GS can also perform special operations such as starting or pausing the game, and push the game screen to the live streaming system.

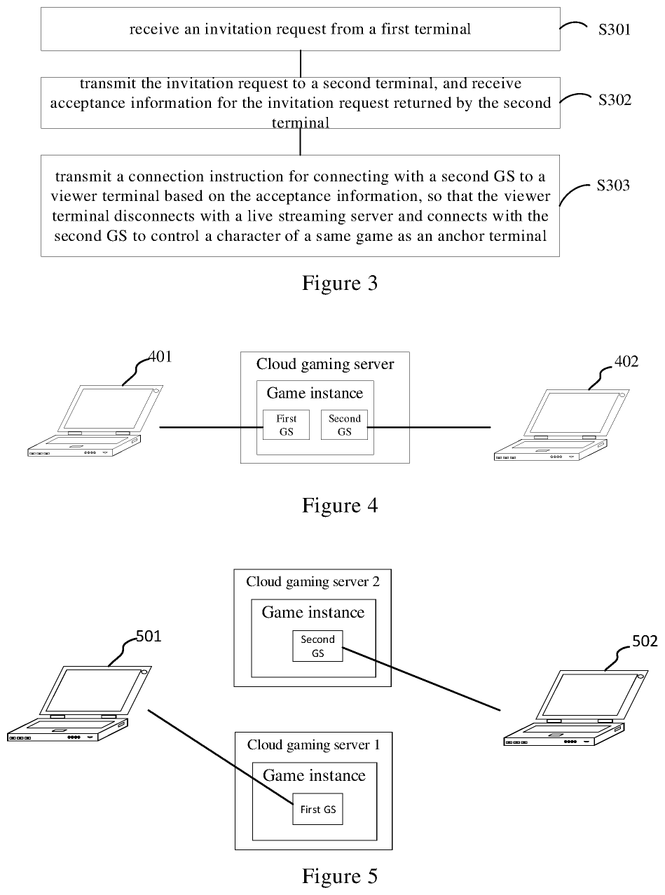

FIG. 4 illustrates an anchor terminal 401, a first GS, a second GS and a viewer terminal 402. Both the first GS and the second GS can be integrated in a same game. For example, the first GS and the second GS can be integrated in an identical game instance of a same game. This situation can be applicable to console OSD (On Screen Display) games. Here, the first GS connected to the anchor terminal 401 may be the master GS.

FIG. 5 illustrates an anchor terminal 501, a first GS, a second GS, and a viewer terminal 502. The first GS can be integrated into one game instance of a same game, and the second GS can be integrated into another game instance of the same game. This situation can be applicable to online games. Here, the first GS and the second GS can be different master GS, but the operations such as start or pause of the game can still be uniformly controlled by the anchor terminal.

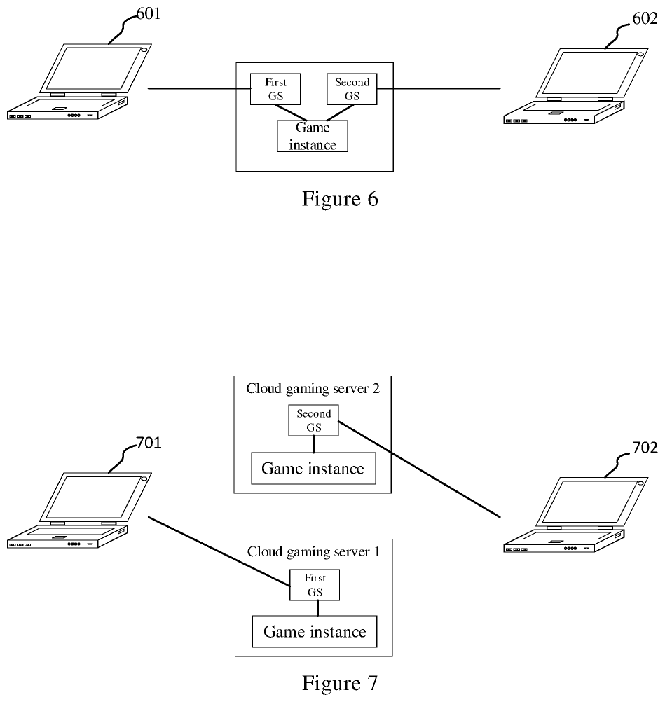

FIG. 6 illustrates an anchor terminal 601, a first GS, a second GS, and a viewer terminal 602. The first GS and the second GS are independent of a same game. Both the first GS and the second GS can be used to control an identical game instance of the same game. This situation can also be applicable to a stand-alone-single screen game. Here, the first GS connected to the anchor terminal 601 can be the master GS.

FIG. 7 illustrates an anchor terminal 701, a first GS, a second GS, and a viewer terminal 702. The first GS and the second GS are independent of a same game. The first GS can be used to control one instance of the same game, and the second GS can be used to control another instance of the same game. This situation can also be applied to online games. Here, the first GS and the second GS can be different master GS, but the operations such as start or pause of the game can still be uniformly controlled by the anchor terminal.

According to a possible implementation of the embodiments of the disclosure, before the step S303 of transmitting a connection instruction for connecting with a second GS to a viewer terminal based on the acceptance information, the method further includes the following steps.

(1) An authorization request is transmitted to the anchor, the authorization request being used to request to transmit a connection instruction to the viewer; and

(2) Authorization confirmation information is received from the anchor terminal.

Specifically, before the signaling server transmits the connection instruction to the viewer terminal, the signaling server can also transmit an authorization request to the anchor terminal, and after receiving the confirmation of authorization information of the anchor terminal, the signaling server transmits the connection instruction to the viewer terminal in response to the confirmation of authorization information.

In other implementation processes, the anchor terminal can also authorize the signaling server in advance, that is, after receiving the acceptance information from the viewer terminal, the signaling server does not need to transmit an authorization request to the anchor terminal, but directly transmits a connection instruction to the viewer terminal.

In the above live streaming interaction method, the anchor terminal transmits an invitation request to the signaling server, and the signaling server transmits the invitation request to the viewer terminal and receives the acceptance information from the viewer terminal. Or, the viewer terminal transmits an invitation request to the signaling server, and the signaling server transmits the invitation request to the anchor terminal and receives acceptance information from the anchor terminal. The anchor terminal is connected with the first GS; and the signaling server transmits a connection instruction for connecting with the second GS to the viewer terminal. The viewer terminal disconnects with the live streaming server and connects with the second GS based on the connection instruction. The first GS and the second GS control game instance(s) of the same game, so combining the game with live streaming is achieved. During the live streaming, the anchor terminal and the viewer terminal can control the same or different characters of the same game.

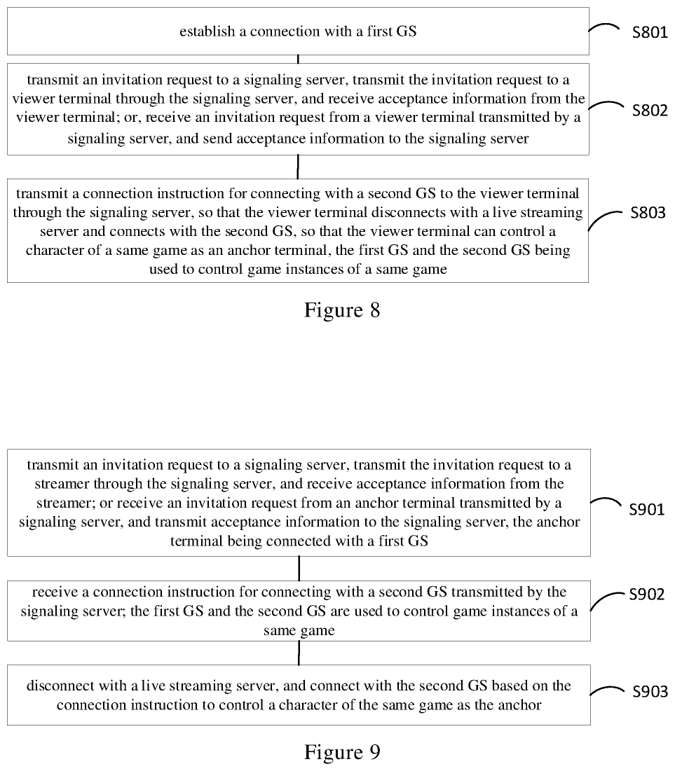

In an embodiment, a live streaming interaction method is provided, as shown in FIG. 8, which is applicable to an anchor terminal and which may include:

Step S801, a connection with a first GS is established;

Step S802, an invitation request is transmitted to a signaling server, the invitation request is transmitted to a viewer terminal through the signaling server, and an acceptance information is received from the viewer terminal; or, an invitation request is received from a viewer terminal sent by a signaling server, and an acceptance information is transmitted to the signaling server.

Here, the acceptance information of the viewer terminal may be the acceptance information returned by the viewer terminal in response to the invitation request; and the acceptance information sent from the anchor terminal to the signaling server may be the acceptance information returned to the signaling server in response to the anchor terminal's invitation request.

Specifically, the anchor terminal can transmit an invitation request to the signaling server, and the signaling server transmits the invitation request to the viewer terminal and receives the acceptance information from the viewer terminal. In this way, the invitation request can include the interactive game, the number of game players and the interactive rules designated by the anchor terminal. The viewer terminal can also transmit an invitation request to the signaling server, and the signaling server transmits the invitation request to the anchor terminal and receives the acceptance information of the anchor terminal. In this way, the viewer terminal cannot specify the interactive game, the number of game players, or the interactive rules in the invitation request, and the viewer terminal can only request to play the same game as the anchor terminal.

Step S803, a connection instruction for connecting with a second GS is transmitted to the viewer terminal through the signaling server, so that the viewer terminal disconnects with a live streaming server and connects with the second GS, so that the viewer terminal can control a character of a same game as an anchor terminal, the first GS and the second GS are used to control game instance(s) of a same game.

Here, the same game as the anchor terminal means that the game where the character controlled by the viewer terminal is located is the same as the game where the character controlled by the anchor terminal is located.

Here, the anchor terminal connects with the first GS. The first GS and the second GS can be used to control the game instance(s) of the same game. For example, the first GS and the second GS can control the same game instance of the same game. For another example, the first GS can control one game instance of the same game, and the second GS can control another game instance of the same game. When the viewer terminal is connected to the second GS, the viewer terminal can control a character of a same game as the anchor terminal.

In the specific implementation process, the viewer terminal can control an identical character of a same game as the anchor terminal, or can control a different character of a same game as the anchor terminal. There is no restriction on whether the specific controlled character is the same.

According to a possible implementation of the embodiments of the disclosure, the live streaming interaction method may further include:

(1) receiving an authorization request from the signaling server; and

(2) transmitting authorization confirmation information to the signaling server, the authorization confirmation information being used to instruct the signaling server to transmit a connection instruction to the viewer terminal.

Specifically, before the signaling server transmits the connection instruction to the viewer terminal, the signaling server may also transmit an authorization request to the anchor terminal. After the anchor terminal transmits the confirmation of authorization information, the signaling server transmits the connection instruction to the viewer terminal in response to the confirmation of authorization information.

In other implementation processes, the anchor terminal can also pre-authorize the signaling server. That is, after receiving the acceptance information of the viewer terminal, the signaling server does not need to transmit an authorization request to the anchor terminal, but directly transmits a connection instruction to the viewer terminal.

In the above live streaming interaction method, the anchor terminal transmits an invitation request to the signaling server, and the signaling server transmits the invitation request to the viewer terminal and receives the acceptance information from the viewer terminal. Or, the viewer terminal transmits an invitation request to the signaling server, and the signaling server transmits the invitation request to the anchor terminal and receives acceptance information from the anchor terminal. The anchor is connected with the first GS; and the signaling server transmits a connection instruction for connecting with the second GS to the viewer terminal. The viewer terminal disconnects with the live streaming server and connects with the second GS based on the connection instruction. The first GS and the second GS control game instance(s) of the same game, thereby combining the game with live streaming is achieved. Therefore, the anchor terminal and the viewer terminal can control the same or different characters of the same game during the live streaming.

In an embodiment, a live streaming interaction method is provided, as shown in FIG. 9, which is applicable to the viewer terminal, and which may include:

Step S901, an invitation request is transmitted to a signaling server, the invitation request is transmitted to an anchor through the signaling server, and acceptance information is received from the anchor; or an invitation request is received from an anchor terminal sent by a signaling server, and acceptance information is transmitted to the signaling server, the anchor terminal is connected with a first GS.

Here, the acceptance information of the anchor terminal may be the acceptance information returned by the anchor terminal in response to the invitation request; and the acceptance information sent from the viewer terminal to the signaling server may be the acceptance information returned by the viewer terminal in response to the anchor terminal's invitation request.

Specifically, the anchor terminal can transmit an invitation request to the signaling server, and the signaling server transmits the invitation request to the viewer terminal and receives the acceptance information from the viewer terminal. In this way, the invitation request can include the interactive game, the number of game players, and the interaction rules designated by the anchor. The viewer terminal can also transmit an invitation request to the signaling server, and the signaling server transmits the invitation request to the anchor terminal and receives the acceptance information of the anchor terminal. In this way, the viewer terminal cannot specify the interactive game, the number of game players, or the interactive rules in the invitation request, and the viewer terminal can only request to play the same game as the anchor terminal.

Step S902, a connection instruction for connecting with a second GS sent by the signaling server is received; the first GS and the second GS are used to control game instances of a same game.

Specifically, the anchor terminal can be connected with the first GS, and the first GS and the second GS can be used to control game instance(s) of the same game, for example, the first GS and the second GS can control a same game instance of the same game. Alternatively, the first GS can control one game instance of the same game, and the second GS can control another game instance of the same game. When the viewer terminal is connected to the second GS, the viewer terminal can control a same or different character of the same game as the anchor terminal.

Step S903, the viewer terminal disconnects with a live streaming server and connects with the second GS based on the connection instruction, to control a character of the same game as the anchor terminal.

Here, the same game as the anchor terminal means that the game where the character controlled by the viewer terminal is located and the game where the character controlled by the anchor terminal is located are the same game.

In the above live streaming interaction method, the anchor terminal transmits an invitation request to the signaling server, and the signaling server transmits the invitation request to the viewer terminal and receives the acceptance information from the viewer terminal. Or, the viewer terminal transmits an invitation request to the signaling server, and the signaling server transmits the invitation request to the anchor terminal and receives acceptance information from the anchor terminal. The anchor terminal is connected with the first GS; and the signaling server transmits a connection instruction for connecting with the second GS to the viewer terminal. The viewer terminal disconnects with the live streaming server and connects with the second GS based on the connection instruction. The first GS and the second GS control game instance(s) of the same game, thereby combining the game with live streaming is achieved. Therefore, the anchor terminal and the viewer terminal can control the same or different characters of the same game during the live streaming.

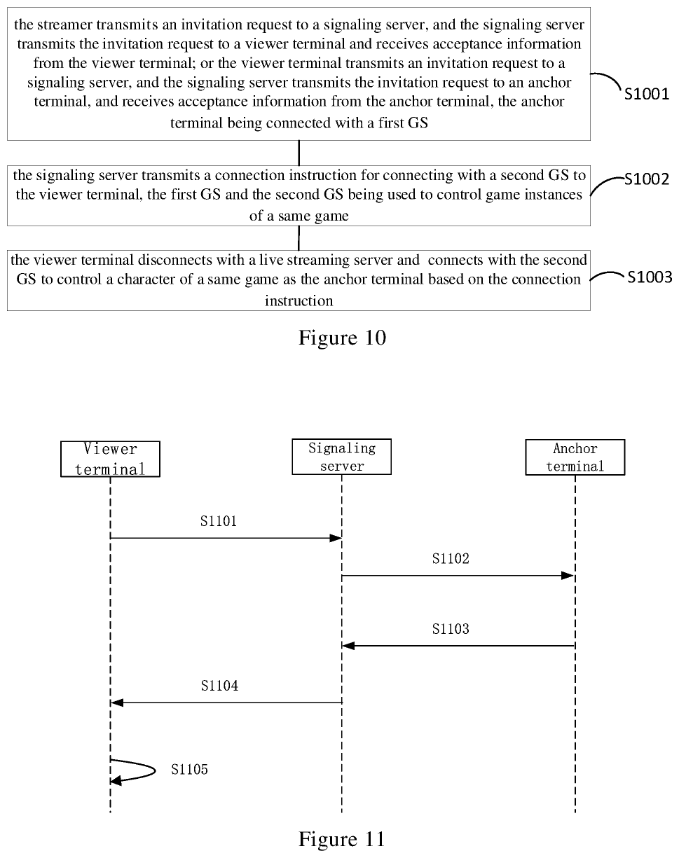

In an embodiment, a live streaming interaction method is provided, which is explained from the perspective of interaction among the anchor terminal, the signaling server, and the viewer terminal, as shown in FIG. 10, which may include:

Step S1001, the anchor terminal transmits an invitation request to a signaling server, and the signaling server transmits the invitation request to a viewer terminal and receiving an acceptance information from the viewer terminal; or the viewer terminal transmits an invitation request to a signaling server, and the signaling server transmits the invitation request to an anchor terminal and receives an acceptance information from the anchor terminal, the anchor terminal being connected with a first GS.

Here, the acceptance information of the viewer terminal may be the acceptance information returned by the viewer terminal in response to the invitation request; and the acceptance information of the anchor terminal may be the acceptance information returned by the anchor terminal in response to the invitation request.

Specifically, the anchor terminal can transmit an invitation request to the signaling server, and the signaling server transmits the invitation request to the viewer terminal, and receives the acceptance information from the viewer terminal. In this way, the invitation request can include the interactive game, the number of game players and the interactive rules designated by the anchor terminal. The viewer terminal can also transmit an invitation request to the signaling server, and the signaling server transmits the invitation request to the anchor terminal and receives the acceptance information of the anchor terminal. In this way, the viewer terminal cannot specify the interactive game, the number of game players, or the interactive rules in the invitation request, and the viewer terminal can only request to play the same game as the anchor terminal.

Step S1002, the signaling server transmitting a connection instruction for connecting with a second GS to the viewer terminal, the first GS and the second GS being used to control game instance(s) of a same game.

Step S1003, the viewer terminal disconnects with a live streaming server and connects with the second GS to control a character of a same game as the anchor terminal based on the connection instruction.

Here, the same game as the anchor terminal means that the game where the character controlled by the viewer terminal is located and the game where the character controlled by the anchor terminal is located are the same game.

Specifically, the anchor terminal can be connected to the first GS, and the first GS and the second GS can be used to control game instance(s) of the same game. For example, the first GS and the second GS can control the same game instance of the same game. For another example, the first GS can control one game instance of the same game, and the second GS can control another game instance of the same game. When the viewer terminal is connected with the second GS, the viewer terminal can control a character of a same game as the anchor terminal.

In the above live streaming interaction method, the anchor transmits an invitation request to the signaling server, and the signaling server transmits the invitation request to the viewer and receives the acceptance information from the viewer. Or, the viewer transmits an invitation request to the signaling server, and the signaling server transmits the invitation request to the anchor and receives acceptance information from the anchor. The anchor is connected to the first GS; and the signaling server transmits a connection instruction for connecting with the second GS to the viewer. The viewer disconnects with the live streaming server and connects with the second GS based on the connection instruction. The first GS and the second GS control game instance(s) of the same game, thereby combining the game with the live streaming is achieved. Therefore, the anchor terminal and the viewer terminal can control the same or different characters of the same game during the live streaming.

In order to better understand the above live streaming interaction method, as shown in FIG. 11, an example of the live streaming interaction of the disclosure is described in detail below:

In an example, a live streaming interaction method provided in the disclosure may include the following steps.

Step S1101, a viewer terminal transmits an invitation request to a signaling server, requesting to play a same game with an anchor terminal.

Step S1102, the signaling server transmits the invitation request to the anchor terminal which is connected with a first GS.

Step S1103, the anchor terminal transmits an acceptance information of the invitation request to the signaling server.

Step S1104, the signaling server transmits a connection instruction of a second GS to the viewer terminal.

Step S1105, the viewer terminal disconnects with a live streaming server and connects with the second GS to control a character of the same game as the anchor terminal based on the connection instruction.

In the above example, the viewer terminal transmits an invitation request to the signaling server, requesting to play the same game with the anchor terminal. The anchor terminal can be connected to the first GS, the signaling server can transmit the invitation request to the anchor terminal, and transmit the connection instruction of the second GS to the viewer terminal based on the acceptance information of the anchor terminal. The viewer terminal disconnects with a live streaming server and connects with the second GS to realize that the anchor terminal and the viewer terminal can play the same game together. The first GS and the second GS can be used to control a same game instance of a same game, and the first GS can be the master GS. The master control GS can up-stream the game screen to the live streaming system, so that the anchor terminal, as well as all the viewer terminals in the live streaming room, can watch the game screen.

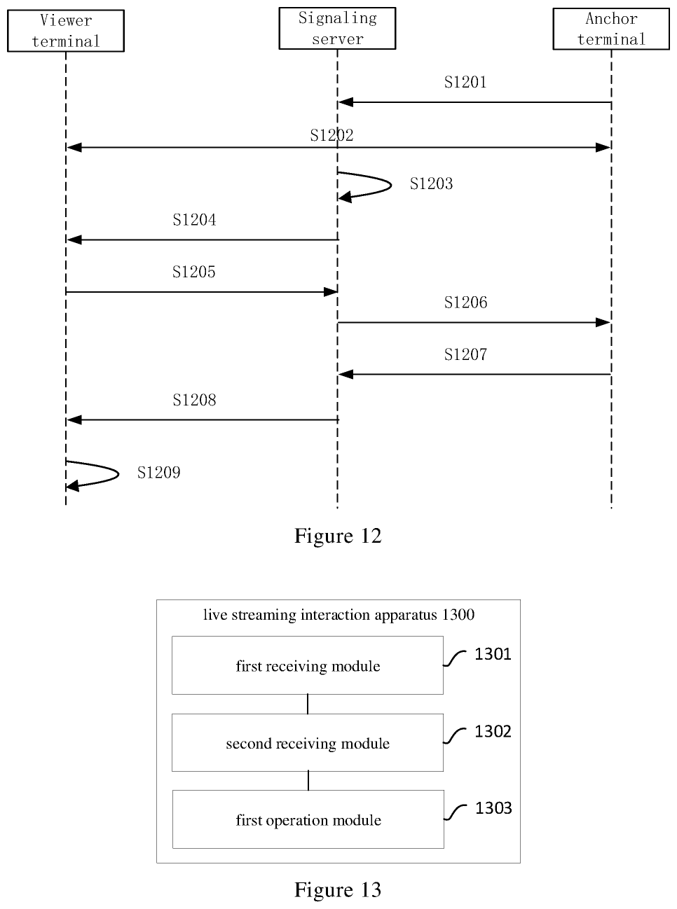

In order to better understand the above live streaming interaction method, as shown in FIG. 12, an example of the live streaming interaction of the disclosure is described in detail below.

In an example, the live streaming interaction method provided in the disclosure may include the following steps.

Step S1201, an anchor terminal transmits an invitation request to a signaling server, and the invitation request carries an interactive game, the number of game players and interactive rules.

Step S1202, the signaling server broadcasts the interactive game, the number of game players and the interactive rules to the anchor terminal in a live streaming room and all viewer terminals.

Step S1203, the signaling server determines a viewer terminal to be invited based on the interaction rules.

Step S1204, the signaling server transmits the invitation request to the determined viewer terminal to be invited.

Step S1205, the viewer terminal transmits an acceptance information for the invitation request to the signaling server.

Step S1206, the signaling server transmits an authorization request to the anchor terminal.

Step S1207, the anchor terminal transmits the confirmation of authorization information for the authorization request to the signaling server.

Step S1208, the signaling server transmits a connection instruction to the determined viewer terminal to be invited.

Step S1209, the viewer terminal disconnects with the live streaming server and connects with a second GS, the anchor terminal connects with a first GS, and the first GS and the second GS are used to control game instance(s) of a same game.

In the above example, the anchor terminal transmits the invitation request to the signaling server, and the signaling server broadcasts the interactive game, number of game players and interaction rules in the invitation request to the anchor terminal and all viewer terminals in the live streaming room, and determines the to-be-invited viewer terminal. After the signaling server obtains the confirmation of authorization information from the anchor terminal, the signaling server transmits the connection instruction to the to-be-invited viewer terminal. The viewer terminal, based on the connection instruction, disconnects with the live streaming server and connects with the second GS, so that the anchor terminal and the viewer terminal can play the same game together. The first GS is used to control one game instance of the same game, the second GS is used to control another game instance of the same game. The first GS can be the master GS, and the master GS up-streams the game screen to the live streaming system, so that the anchor terminal and all viewer terminals in the live streaming room can watch the game screen.

The embodiment of the disclosure provides a live streaming interaction apparatus 1300. As shown in FIG. 13, the live streaming interaction apparatus 1300 includes: a first receiving module 1301, a second receiving module 1302, and a first operation module 1303.

The first receiving module 1301 is configured to receive an invitation request of a first terminal;

The second receiving module 1302 is configured to transmit the invitation request to a second terminal, and receive acceptance information for the invitation request returned by the second terminal.

The first operation module 1303 is configured to transmit a connection instruction for connecting with a second GS to a viewer terminal based on the acceptance information, so that the viewer terminal disconnects with a live streaming server and connects with the second GS to control a character of a same game as an anchor terminal.

Here, the anchor terminal connects with a first GS; the first GS and the second GS are used to control game instance(s) of the same game; the viewer terminal is one of a first and second terminal; and the anchor terminal is the other one of the first terminal and the second terminal except the viewer terminal.

According to a possible implementation of the embodiments of the disclosure, the anchor terminal is the first terminal; the viewer terminal is the second terminal; the invitation request carries interaction information; the interaction information includes an interactive game and the number of interactive people designated by the anchor terminal.

According to a possible implementation of the embodiments of the disclosure, the interaction information further includes interaction rules; and when the second receiving module 1302 transmits the invitation request to the second terminal, the second receiving module 1302 is specifically configured for:

broadcasting the interaction information to multiple user terminals in a live streaming room respectively; and

searching for a user terminal that meets the interaction rules, taking the found user terminal as a viewer terminal, and transmitting the invitation request to the viewer terminal.

According to a possible implementation of the embodiments of the disclosure, the interaction information further includes a viewer terminal designated by the anchor terminal; and when the second receiving module 1302 transmits the invitation request to the second terminal, the second receiving module 1302 is specifically configured for:

transmitting the invitation request to the viewer terminal designated by the anchor terminal.

According to a possible implementation of the embodiments of the disclosure, both the first GS and the second GS are integrated in a same game;

or, both the first GS and the second GS are independent of a same game, and both the first GS and the second GS are used to control a same game instance of the same game;

or, the first GS and the second GS are both independent of a same game, the first GS is used to control one game instance of the same game, and the second GS is used to control another game instance of the same game.

According to a possible implementation of the embodiments of the disclosure, the live streaming interaction apparatus further includes a first authorization module, and the first authorization module is configured to:

transmitting an authorization request to the anchor, the authorization request being used to request to transmit a connection instruction to the viewer; and

receiving a confirmation of the authorization information from the anchor.

In the above live streaming interaction apparatus, the anchor transmits an invitation request to the signaling server, and the signaling server transmits the invitation request to the viewer and receives the acceptance information from the viewer. Or, the viewer transmits an invitation request to the signaling server, and the signaling server transmits the invitation request to the anchor and receives acceptance information from the anchor. The anchor is connected to the first GS; and the signaling server transmits a connection instruction for connecting with the second GS to the viewer. The viewer disconnects with the live streaming server and connects with the second GS based on the connection instruction. The first GS and the second GS control game instances of the same game, so the game and live streaming are combined. During the live streaming, the anchor and the viewer can control the character of the same game.

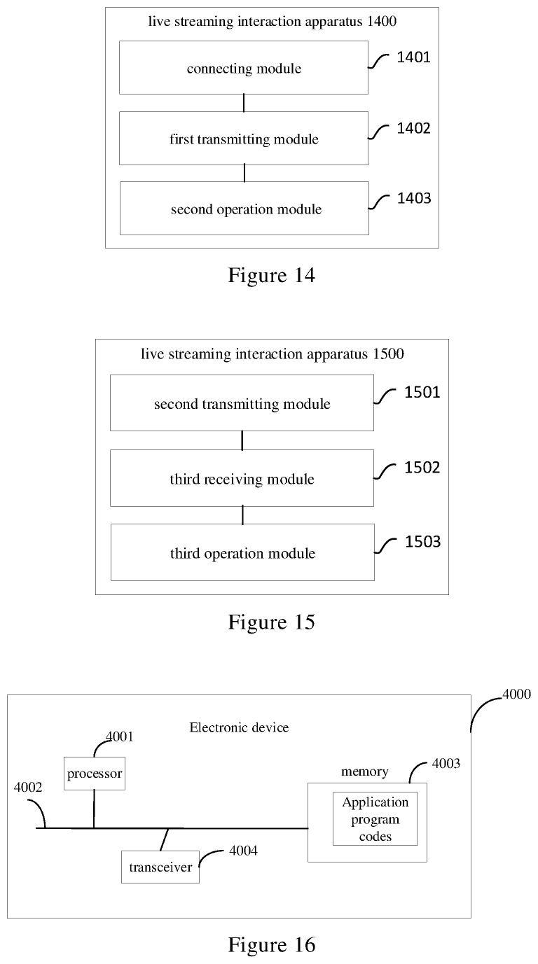

The embodiment of the disclosure provides a live streaming interaction apparatus 1400. As shown in FIG. 14, the live streaming interaction apparatus 1400 includes: a connecting module 1401, a first transmitting module 1402, and a second operation module 1403. Here,

the connecting module 1401 is configured to establish a connection with a first GS;

the first transmitting module 1402 is configured to transmit an invitation request to a signaling server, transmit the invitation request to a viewer terminal through the signaling server, and receive an acceptance information from the viewer terminal: or, receive an invitation request from a viewer terminal sent by a signaling server, and transmit an acceptance information to the signaling server; and

the second operation module 1403 is configured to transmit a connection instruction for connecting with a second GS to the viewer terminal through the signaling server, so that the viewer terminal disconnects with a live streaming server and connects with the second GS, so that the viewer terminal can control a character of a same game as an anchor terminal, the first GS and the second GS being used to control game instance(s) of a same game.

According to a possible implementation of the embodiments of the disclosure, the live streaming interaction apparatus further includes a second authorization module, and the second authorization module is configured as:

receive an authorization request from the signaling server; and

transmitting a confirmation of the authorization information to the signaling server, the confirmation of the authorization information being used to instruct the signaling server to transmit a connection instruction to the viewer terminal.

In the above live streaming interaction apparatus, the anchor transmits an invitation request to the signaling server, and the signaling server transmits the invitation request to the viewer and receives the acceptance information from the viewer. Or, the viewer transmits an invitation request to the signaling server, and the signaling server transmits the invitation request to the anchor and receives acceptance information from the anchor. The anchor is connected to the first GS; and the signaling server transmits a connection instruction for connecting with the second GS to the viewer. The viewer disconnects with the live streaming server and connects with the second GS based on the connection instruction. The first GS and the second GS control game instances of the same game, so the game and live streaming are combined. During the live streaming, the anchor and the viewer can control the character of the same game.

An embodiment of the disclosure provides a live streaming interaction apparatus 1500. As shown in FIG. 15, the live streaming interaction apparatus 1500 includes: a second transmitting module 1501, a third receiving module 1502, and a third operation module 1503. Here,

the second transmitting module 1501 is configured to transmit an invitation request to a signaling server, transmit the invitation request to an anchor through the signaling server, and receive an acceptance information from the anchor; or receive an invitation request from an anchor terminal sent by a signaling server, and transmit an acceptance information to the signaling server, the anchor terminal being connected to a first GS;

the third receiving module 1502 is configured to receive a connection instruction for connecting with a second GS sent by the signaling server, the first GS and the second GS being used to control game instances of a same game; and

the third operation module 1503 is configured to disconnect with a live streaming server, and connect with the second GS based on the connection instruction to control a character of the same game as the anchor terminal.

In the above live streaming interaction apparatus, the anchor transmits an invitation request to the signaling server, and the signaling server transmits the invitation request to the viewer and receives the acceptance information from the viewer. Or, the viewer transmits an invitation request to the signaling server, and the signaling server transmits the invitation request to the anchor and receives acceptance information from the anchor. The anchor is connected to the first GS; and the signaling server transmits a connection instruction for connecting with the second GS to the viewer. The viewer disconnects with the live streaming server and connects with the second GS based on the connection instruction. The first GS and the second GS control game instances of the same game, so the game and live streaming are combined. During the live streaming, the anchor and the viewer can control the character of the same game.

The live streaming interaction apparatus of the embodiments of the present disclosure can execute a live streaming interaction method provided by the embodiments of the present disclosure, and its implementation principle is similar. The actions performed by the modules in the live streaming interaction apparatus in each embodiment of the present disclosure correspond to the steps in the live streaming interaction method in each embodiment of the present disclosure. For the detailed functional description of each module of the live streaming interaction apparatus, please refer to the description in the corresponding live streaming interaction method shown in the foregoing text, which will not be repeated here.

Based on the same principle as the method shown in the embodiments of the present disclosure, the embodiments of the present disclosure also provide an electronic device, which may include, but is not limited to: a processor and a memory; the memory is used to store computer operation instructions; and the processor is used to execute the method shown in the embodiments by calling the computer operation instructions. Compared with the prior art, the electronic device in the disclosure can realize the combination of game and live streaming.

In an optional embodiment, an electronic device is provided. As shown in FIG. 16, the electronic device 4000 shown in FIG. 16 includes: a processor 4001 and a memory 4003. Here, the processor 4001 and the memory 4003 may be connected, for example, through a bus 4002. Optionally, the electronic device 4000 may further include a transceiver 4004. It should be noted that in practical applications, the transceiver 4004 is not limited to one, and the structure of the electronic device 4000 does not constitute a limitation to the embodiments of the disclosure.

The processor 4001 may be a central processing unit (Central Processing Unit, central processing unit), a general-purpose processor, DSP (Digital Signal Processor), ASIC (Application Specific Integrated Circuit), FPGA (Field Programmable Gate Array) or other programmable logic devices, transistor logic devices, hardware components or any combination thereof. The processor 4001 can implement or execute various exemplary logical blocks, modules, and circuits described in conjunction with the disclosure. The processor 4001 may also be a combination for realizing computing functions, for example, including a combination of one or more microprocessors, a combination of a DSP and a microprocessor, and so on.

The bus 4002 may include a path for transferring information among the above-mentioned components. The bus 4002 may be a PCI (Peripheral Component Interconnect) bus or an EISA (Extended Industry Standard Architecture) bus or the like. The bus 4002 can be divided into an address bus, a data bus, a control bus, and so on. For ease of presentation, only one thick line is used in FIG. 16, but it does not mean that there is only one bus or one type of bus.

The memory 4003 can be ROM (Read Only Memory) or other types of static storage devices that can store static information and instructions, RAM (Random Access Memory, random access memory), or other types of dynamic storage device that can store information and instructions. The memory 4003 can also be EEPROM (Electrically Erasable Programmable Read Only Memory), CD-ROM (Compact Disc Read Only Memory) or other optical disk storage, optical disk storage (including compressed optical discs, laser CDs, CDs, digital universal CDs, Blu-ray CDs, etc.), disk storage media, or other magnetic storage devices, any other medium that can be used to carry or store desired program codes in the form of instructions or data structures and that can be accessed by a computer, but is not limited to this.

The memory 4003 may be used to store application program codes used to execute the solutions of the disclosure, and the processor 4001 controls the execution of the codes. The processor 4001 may be used to execute the application program codes stored in the memory 4003 to implement the content shown in the foregoing method embodiments.

Here, electronic devices include but are not limited to: mobile terminals, such as mobile phones, notebook computers, digital broadcast receivers, PDAs (personal digital assistants), PADs (tablets), PMPs (portable multimedia players), vehicle-mounted terminals (such as Car navigation terminal) and other mobile terminals, as well as fixed terminals, such as digital TV, desktop computers, etc. The electronic device shown in FIG. 16 is only an example, and should not bring any limitation to the function and scope of use of the embodiments of the present disclosure.

The embodiments of the disclosure provide a computer-readable storage medium with a computer program stored on the computer-readable storage medium, and when the computer program runs on a computer, the computer can execute the corresponding content in the foregoing method embodiment. Compared with the prior art, the computer-readable storage medium provided in the disclosure can realize the combination of game and live streaming.

Although the various steps in the flowchart of the drawings are displayed in sequence as indicated by the arrows, these steps are not necessarily performed in the order indicated by the arrows. Unless explicitly stated in the disclosure, the execution of these steps is not strictly limited in certain order, and they can be executed in other orders. Moreover, at least a part of the steps in the flowchart of the drawings may include multiple sub-steps or multiple stages. These sub-steps or stages are not necessarily executed at the same time, but can be executed at different time. The order of execution is not necessarily to be performed sequentially, but may be performed alternately or alternately with other steps or at least a part of the sub-steps or stages of other steps.

It should be noted that the above-mentioned computer-readable medium in the present disclosure may be a computer-readable signal medium or a computer-readable storage medium, or any combination of the two. The computer-readable storage medium may be, for example, but not limited to, an electrical, magnetic, optical, electromagnetic, infrared, or semiconductor system, apparatus, or device, or a combination of any of the above. More specific examples of computer-readable storage medium may include, but are not limited to: electrical connections with one or more wires, portable computer disks, hard disks, random access memory (RAM), read-only memory (ROM), erasable Programmable read-only memory (EPROM or flash memory), optical fiber, portable compact disk read-only memory (CD-ROM), optical storage device, magnetic storage device, or any suitable combination of the above. In the present disclosure, the computer-readable storage medium may be any tangible medium that contains or stores a program, and the program may be used by an instruction execution system, apparatus, or device, or used in combination therewith. In the present disclosure, the computer-readable signal medium may include a data signal propagated in a baseband or as a part of a carrier wave, and a computer-readable program code is carried therein. This propagated data signal can take many forms, including but not limited to electromagnetic signals, optical signals, or any suitable combination thereof. The computer-readable signal medium may also be any computer-readable medium other than a computer-readable storage medium. The computer-readable signal medium may transmit, propagate, or transmit a program for use by an instruction execution system, apparatus, or device, or for use in conjunction therewith. The program code contained on the computer-readable medium can be transmitted by any suitable medium, including but not limited to: wire, optical cable, RF (radio frequency), etc., or any suitable combination of the above.

The above-mentioned computer-readable medium may be included in the above-mentioned electronic device; or may exist alone without being assembled into the electronic device.

The foregoing computer-readable medium carries one or more programs, and when the foregoing one or more programs are executed by the electronic device, the electronic device is caused to execute the method shown in the foregoing embodiments.

One or more programming languages or a combination thereof can be used to write computer program codes for performing the operations of the present disclosure. The above-mentioned programming languages include but are not limited to: object-oriented programming languages-such as Java, Smalltalk, C++, and include conventional procedural programming languages-such as “C” language or similar programming languages. The program codes can be executed entirely on the user's computer, partly on the user's computer, executed as an independent software package, partly executed on the user's computer, and partly executed on a remote computer, or entirely executed on a remote computer or server. In case of a remote computer, the remote computer can be connected to the user's computer through any kind of network, including a local area network (LAN) or a wide area network (WAN), or can be connected to an external computer (for example, using an Internet service provider and through Internet connection).

The flowcharts and block diagrams in the figures illustrate the possible implementation architecture, functions, and operations of the system, method, and computer program product according to various embodiments of the present disclosure. In this regard, each block in the flowchart or block diagram may represent a module, program segment, or part of code, and the module, program segment, or part of the code contains one or more executable instructions for realizing the specified logic function. It should also be noted that, in some alternative embodiments, the functions marked in the block may also occur in a different order from the order marked in the figures. For example, two adjacent blocks can be executed substantially in parallel, or they can sometimes be executed in a reverse order, depending on the functions involved. It should also be noted that each block in the block diagram and/or flowchart, and a combination of blocks in the block diagram and/or flowchart, can be implemented by a dedicated hardware-based system that performs the specified function or operation, or they can be implemented by a combination of dedicated hardware and computer instructions.

The modules or units described in the embodiments of the present disclosure can be implemented in software or hardware. Here, the name of a module or unit does not constitute a limitation on the unit itself under certain circumstances. For example, the first receiving module can also be described as “a module for receiving an invitation request”.

The above description is some embodiments of the present disclosure and the illustration of the applied technical principles. Those skilled in the art should understand that the disclosed scope involved in the present disclosure is not limited to the technical solutions formed by specific combination of the above technical features, rather, the disclosed scope should also include other technical solutions formed by arbitrarily combining the above technical features or their equivalent features without departing from the above disclosed concept. For example, the disclosed scope also includes technical solutions formed by replacing the above-mentioned features with the technical features disclosed in this disclosure (but not limited to) with similar functions.

1. A live streaming interaction method, comprising:
receiving an invitation request from a first terminal;
transmitting the invitation request to a second terminal;
receiving acceptance information for the invitation request returned from the second terminal; and
transmitting a connection instruction for connecting with a second Game Service (GS) to a viewer terminal based on the acceptance information, so that the viewer terminal disconnects with a live streaming server and connects with the second GS to control a character of a same game as an anchor terminal;
wherein, the anchor terminal is connected with a first GS; the first GS and the second GS control a same or different game instance of the same game upon integrating in the same game or independent of the same game; the viewer terminal is one of the first terminal and the second terminal; and the anchor terminal is another one other than the viewer terminal in the first terminal and the second terminal except.

2. The live streaming interaction method of claim 1, wherein the anchor terminal is the first terminal, the viewer terminal is the second terminal, the invitation request carries interaction information, the interaction information includes an interactive game and the number of interactive people designated by the anchor terminal.

3. The live streaming interaction method of claim 2, wherein the interaction information further includes interaction rules; transmitting the invitation request to the second terminal comprises:
broadcasting the interaction information to multiple user terminals in a live streaming room respectively; and
searching for a user terminal that meets the interaction rules from the user terminals, taking the searched user terminal as a viewer terminal, and transmitting the invitation request to the viewer terminal.

4. The live streaming interaction method of claim 2, wherein the interaction information further includes information from a viewer terminal designated by the anchor terminal, transmitting the invitation request to a second terminal comprises:
transmitting the invitation request to the second terminal comprises:
transmitting the invitation request to the viewer terminal designated by the anchor terminal.

5. The live streaming interaction method of claim 1, wherein both the first GS and the second GS are integrated in the same game;
or, the first GS and the second GS are both independent of the same game, and both the first GS and the second GS control a same game instance of the same game;
or, the first GS and the second GS are both independent of the same game, the first GS controls one game instance of the same game, and the second GS controls another game instance of the same game.

6. The live streaming interaction method of claim 1, further comprising:
before transmitting the connection instruction for connecting with a second GS to the viewer terminal based on the acceptance information,
transmitting, to the anchor terminal, an authorization request for requesting to transmit the connection instruction to the viewer terminal; and
receiving authorization confirmation information from the anchor terminal.

7. A live streaming interaction method, comprising:
establishing a connection with a first Game Service (GS);
transmitting an invitation request to a signaling server, wherein transmitting the invitation request to a viewer terminal through the signaling server, and receiving acceptance information from the viewer terminal; or, receiving an invitation request from a viewer terminal sent by a signaling server, and transmitting acceptance information to the signaling server; and
transmitting a connection instruction for connecting with a second GS to the viewer terminal through the signaling server, such that the viewer terminal disconnects with a live streaming server and connects with the second GS, so that the viewer terminal controls a character of a same game as an anchor terminal, the first GS and the second GS being used to control a same of different game instance of the same game upon integrating in the same game or independent of the same game.

8. The live streaming interaction method of claim 7, further comprising:
receiving an authorization request from the signaling server; and
transmitting authorization confirmation information to the signaling server, the authorization confirmation information being used to instruct the signaling server to transmit a connection instruction to the viewer terminal.

9. A live streaming interaction method, comprising:
transmitting an invitation request to a signaling server, wherein transmitting the invitation request to an anchor through the signaling server, and receiving an acceptance information from the anchor; or receiving an invitation request from an anchor terminal sent by a signaling server, and transmitting an acceptance information to the signaling server, the anchor terminal being connected with a first Game Service (GS);
receiving a connection instruction for connecting with a second GS sent by the signaling server; the first GS and the second GS are used to control a same or different game instance of a same game upon integrating in the same game or independent of the same game; and
disconnecting with a live streaming server and connecting with the second GS based on the connection instruction, to control a character of the same game as the anchor.

10. (canceled)

11. (canceled)

12. (canceled)

13. (canceled)

14. An electronic device, comprising:
one or more processors;
a memory; and
one or more application programs, the one or more application programs stored in the memory and configured to be executed by the one or more processors, the one or more programs configured to perform the live streaming interaction method of claim 1.

15. A computer-readable storage medium storing computer programs thereon, which implements the live streaming interaction method of claim 1 upon executed by a processor.
